(19) United States
(12) Patent Application Publication
(10) Pub. No.: US 2012/0045240 A1
(43) Pub. Date: Feb. 23, 2012

(54) FIXING DEVICE AND IMAGE FORMING APPARATUS

(75) Inventor: Yosuke SHIMIZU, Toyokawa-shi (JP)

(73) Assignee: Konica Minolta Business Technologies, Inc., Chiyoda-ku (JP)

(21) Appl. No.: 13/193,661

(22) Filed: Jul. 29, 2011

(30) Foreign Application Priority Data
Aug. 19, 2010 (JP) 2010-183733

(51) Int. Cl. G03G 15/20

(52) U.S. Cl. 399/69; 399/334

(57) ABSTRACT

A fixing device including a fixing rotational body and fixing images on sheets of various sizes, comprising: a main excitation coil heating the rotational body by electromagnetic induction and having an effective heating length L1 corresponding to a maximum-size sheet; an auxiliary excitation coil having an effective heating length L2 shorter than L1; a high-frequency power source supplying power to the main and auxiliary coils; and a switch selectively connecting the main or auxiliary coils to the power source, wherein the main coil is positioned along an outer circumferential surface of the rotational body, the auxiliary coil is positioned farther from the rotational body than the main coil is and layered on a central portion of the main coil in a longitudinal direction thereof, and L2 satisfies the following relationship: L2≦L1·η2/η1, where η1 and η2 are thermal conversion efficiencies of the main and auxiliary coils, respectively.

This application is based on an application No. 2010-183733 filed in Japan, the contents of which are hereby incorporated by reference.

### BACKGROUND OF THE INVENTION

(1) Field of the Invention

The present invention relates to a fixing device and an image forming apparatus, and in particular to a technology for preventing overheating in regions where recording sheets do not pass through, together with aiming to reduce size, weight, and cost of the device and the apparatus.

(2) Description of the Related Art

In recent years, for electrophotographic image forming apparatuses, an electromagnetic induction-heating method has been actively studied to realize low heat capacity and improve temperature rise performance of a fixing member that fuses toner on recording sheets. The electromagnetic induction-heating method is used to heat the fixing member by applying induced current to a metal heat generating layer included in the fixing member with use of an excitation coil.

Recording sheets on which toner is fixed are various in size, and the fixing member has an enough size for fixing toner on recording sheets having the maximum size (hereinafter, referred to as “maximum-size recording sheets”) as a specification. Also, an effective heating length of the excitation coil that heats the fixing member corresponds to the maximum-size recording sheet. Therefore, when toner is fixed on recording sheets having a smaller size (hereinafter, small-size recording sheets), a region where the small-size recording sheets pass through on a surface of the fixing member is deprived of heat by the small-size recording sheets and needs to be heated. However, there is a problem in that if heating continues, the regions where small-size recording sheets do not pass through are overheated, which results in failure of the fixing device.

In view of the above problem, the following three conventional technologies have been proposed, for example.

(1) A fixing member 1505 is a rotator like a fixing roller or a fixing belt, and demagnetization coils 1502 that cancel a magnetic flux generated by an excitation coil 1501 are provided at both ends of the fixing member 1505 in a rotational axis direction thereof. A connection of each of the demagnetization coils 1502 is switched ON and OFF in accordance with a size of recording sheets or a temperature of the regions where recording sheets do not pass through (see Japanese Unexamined Patent Application Publication No. 2007-226126 and FIG. 1).

(2) A plurality of excitation coils 1601 to 1603 each having a short effective heating length are aligned on a fixing member 1504 in the rotational axis direction, and power supply to each of the excitation coils 1601 to 1603 is switched ON and OFF in accordance with a size of recording sheets or a temperature of the regions where recording sheets do not pass through (see Japanese Unexamined Patent Application Publication No. 2001-235962 and FIG. 2).

(3) A main excitation coil 1701 and an auxiliary excitation coil 1702 are aligned in a circumferential direction of the fixing member 1504, and power is supplied to one of the main excitation coil 1701 and the auxiliary excitation coil 1702 in accordance with a size of recording sheets and a temperature of the regions where recording sheets do not pass through. The main excitation coil 1701 has an effective heating length that corresponds to a width of the maximum-size recording sheets, and the auxiliary excitation coil 1702 has an effective heating length that is smaller than an effective heating length of the main excitation coil (see Japanese Unexamined Patent Application Publication No. 2001-332377 and FIG. 3).

However, according to the conventional art (1), the demagnetization coils 1502 cannot completely cancel the magnetic flux generated by the excitation coil 1501, and as shown in FIG. 4, a temperature in regions where small-size recording sheets do not pass through becomes high (solid line 1802). Therefore, for example, when small-size recording sheets pass through at a high speed, output of the excitation coil has to be large, and as a result, the demagnetization coils 1502 cannot effectively prevent overheating in the regions where the small-size recording sheets do not pass through.

Also, according to the conventional art (2), magnetic fluxes generated by the plurality of excitation coils 1601 to 1603 interfere with one another. As a result, as shown in FIG. 5, an uneven temperature distribution occurs in the rotational axis direction of the fixing member, and in particular at joints of the excitation coils 1601 to 1603 (solid line 1901). Accordingly uneven fixation might occur.

According to the conventional art (3), in order to align the excitation coils 1701 and 1702 in the circumferential direction of a fixing rotational body, each of the excitation coils has to be small. As a result, heat generation efficiency decreases. That is, by increasing a distance through which the magnetic flux generated by the excitation coil 1501 passes in the circumferential direction of the fixing rotational body, the heat generation efficiency of each coil can be increased (FIG. 6B).

However, in the case of aligning the excitation coils 1701 and 1702 in the circumferential direction of the fixing rotational body, it is impossible to increase a distance through which the magnetic fluxes generated by the excitation coils 1701 and 1702 pass in the circumferential direction of the fixing rotational body. As a result, it is impossible to prevent reduction of heat generation efficiency of each of coils that correspond to different sizes of recording sheets (FIG. 6A). In addition, if the excitation coils are made large, the fixing member also has to be large, and accordingly the fixing device becomes large.

Thus, each of the conventional arts has a different problem.

### SUMMARY OF THE INVENTION

The present invention has been achieved in view of the above problems, and aims to provide a fixing device and an image forming apparatus that can realize reduction in size, weight, and cost thereof without having a harmful effect such as uneven temperature distribution and reduction of heat generation efficiency, while preventing overheating in the regions where recording sheets do not pass through.

In order to achieve the above aim, a fixing device pertaining to the present invention includes a fixing rotational body and fixes toner images on recording sheets of various sizes by using the fixing rotational body, the fixing device comprising: a main excitation coil that heats the fixing rotational body by electromagnetic induction and has an effective heating length L1 corresponding to a recording sheet of a maximum size; an auxiliary excitation coil that heats the fixing rotational body by electromagnetic induction and has an effective heating length L2 that is shorter than the effective heating length L1 of the main excitation coil; a high-frequency power source that supplies power to the main excitation coil and the auxiliary excitation coil; and a switch that selectively connects the main excitation coil and the auxiliary excitation coil to the high-frequency power source, wherein the main excitation coil is positioned along a part of an outer circumferential surface of the fixing rotational body, the auxiliary excitation coil is positioned farther from the fixing rotational body than the main excitation coil is and layered on a substantially central portion of the main excitation coil in a longitudinal direction of the main excitation coil, and the effective heating length L2 of the auxiliary excitation coil satisfies the following relationship: L2≦L1·η2/η1, where η1 is a thermal conversion efficiency of the main excitation coil and η2 is a thermal conversion efficiency of the auxiliary excitation coil.

### BRIEF DESCRIPTION OF THE DRAWINGS

These and other objects, advantages and features of the invention will become apparent from the following description thereof taken in conjunction with the accompanying drawings which illustrate a specific embodiment of the invention.

In the drawings:

FIG. 1 shows a structure of a fixing device pertaining to a conventional art using demagnetization coils;

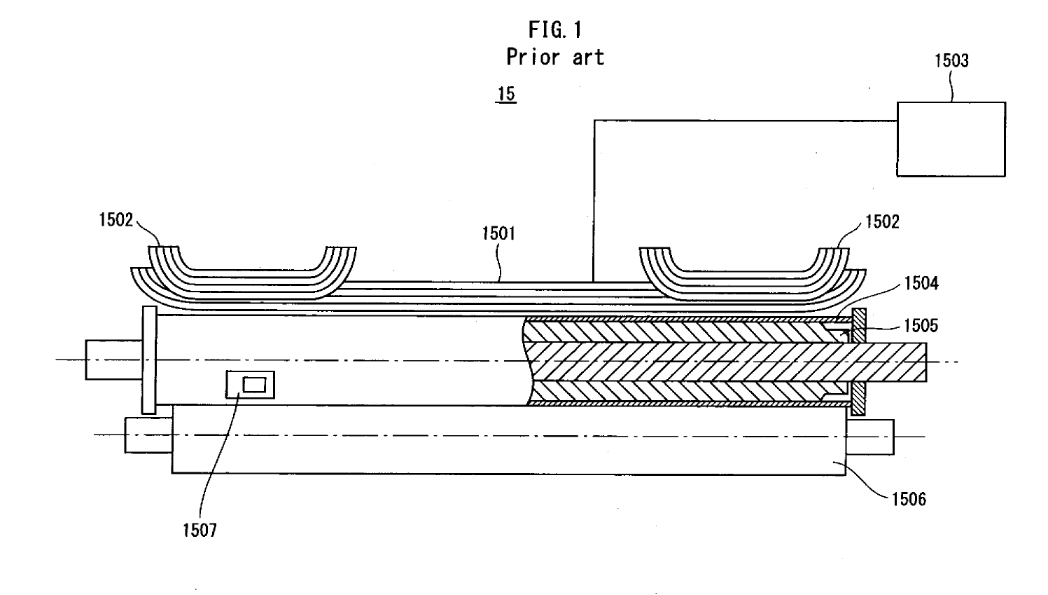

FIG. 2 shows a structure of a fixing device pertaining to a conventional art aligning a plurality of excitation coils in a rotational axis direction of a fixing member;

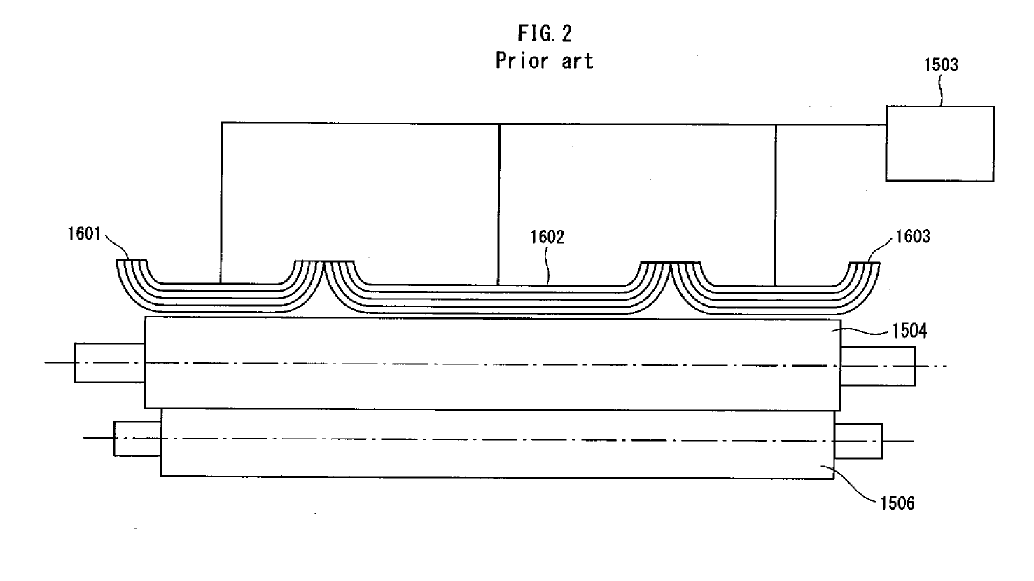

FIG. 3 shows a structure of a fixing device pertaining to a conventional art aligning a plurality of excitation coils in a circumferential direction of the fixing member;

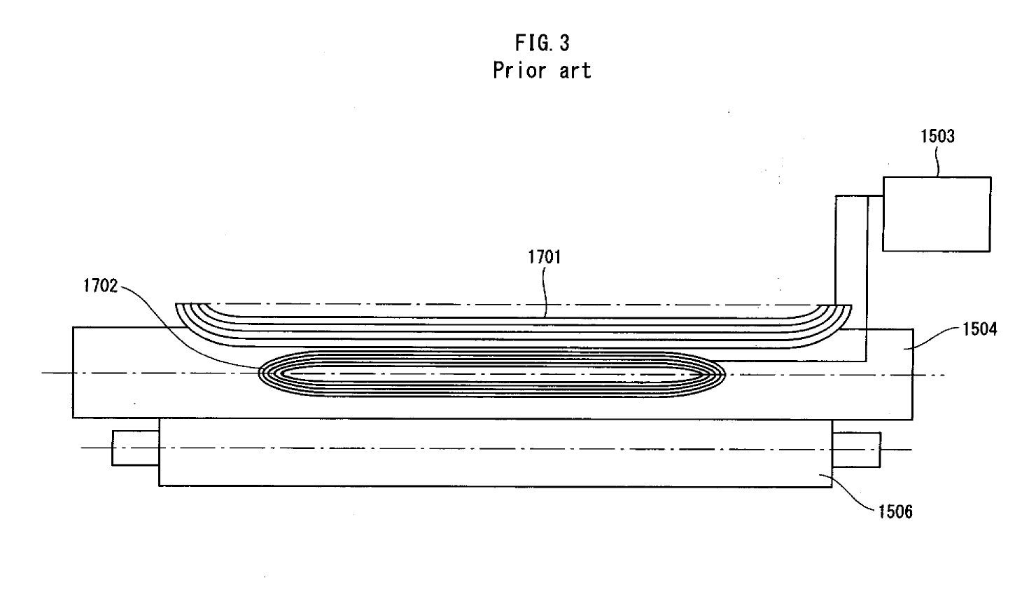

FIG. 4 is a graph showing a temperature distribution of a surface of the fixing member pertaining to the conventional art using the demagnetization coils;

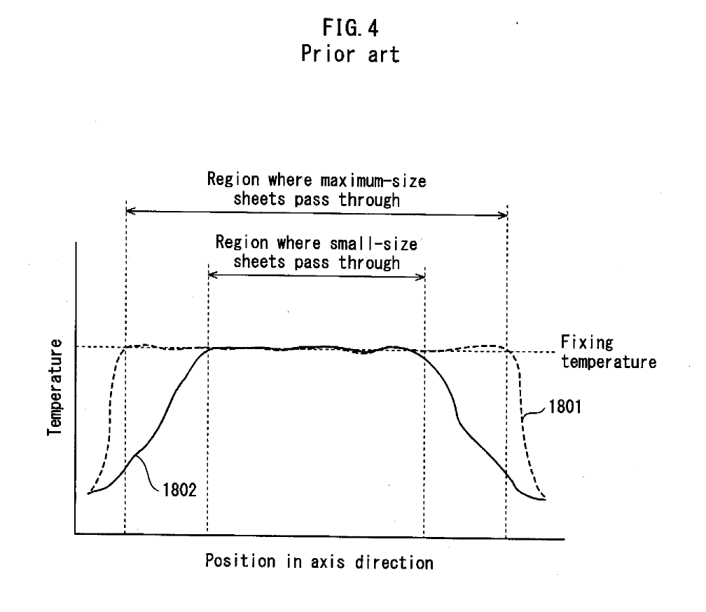

FIG. 5 is a graph showing a temperature distribution of a surface of the fixing member pertaining to the conventional art aligning the plurality of excitation coils in the rotational axis direction of the fixing member;

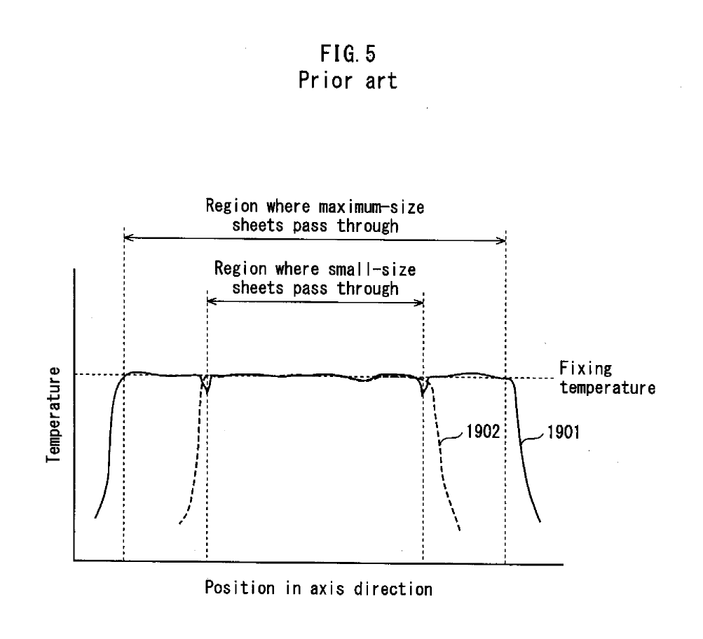

FIGS. 6A and 6B explain heat generation efficiency of the fixing device pertaining to the conventional art aligning the plurality of excitation coils in the circumferential direction of the fixing member;

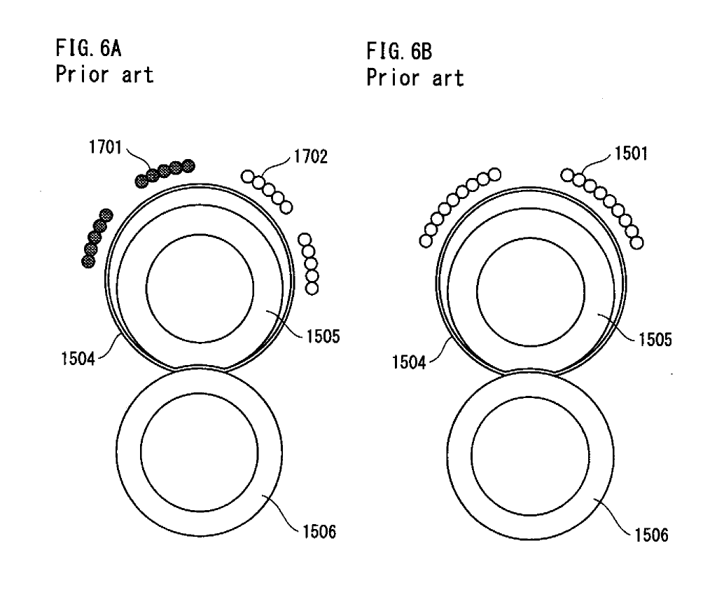

FIG. 7 shows a main structure of an image forming apparatus pertaining to an embodiment of the present invention;

FIG. 8 is a cross-sectional view showing a main structure of a fixing device 115;

FIG. 9 is a cross-sectional view showing a structure of a fixing belt 206;

FIG. 10 shows a circuit structure for controlling power supply to a main excitation coil 207 and an auxiliary excitation coil 215;

FIG. 11 is a lateral view showing a positional relationship between the main excitation coil 207 and the auxiliary excitation coil 215 in a rotational axis direction of a fixing roller 202;

FIG. 12 is a graph showing a relationship between a ratio of an effective heating length of the auxiliary excitation coil to the main excitation coil and heat generation amount per unit length generated by the auxiliary excitation coil having the above ratio within an effective heating area of the fixing belt;

FIG. 13 is a plan view showing a shape of the auxiliary excitation coil 215;

FIG. 14 is a graph showing a temperature distribution during electromagnetic induction heating by the main excitation coil 207 and a temperature distribution during electromagnetic induction heating by the auxiliary excitation coil 215 in the rotational axis direction of the fixing belt 206;

FIG. 15 is an external view of a main structure of a fixing device pertaining to a modification of the present invention;

FIG. 16 is a flowchart showing control of power supply to the main excitation coil 207 and the auxiliary excitation coil 215, which is performed by a controller pertaining to the modification of the present invention;

FIG. 17 is a flowchart showing processing for maximum-size recording sheets pertaining to the modification of the present invention;

FIG. 18 is a flowchart showing processing for recording sheets having a middle size pertaining to the modification of the present invention;

FIG. 19 is a flowchart showing processing for small-size recording sheets pertaining to the modification of the present invention; and

FIG. 20 shows a main structure of the fixing device pertaining to the modification of the present invention.

### DESCRIPTION OF PREFERRED EMBODIMENT

The following describes an embodiment of a fixing device and an image forming apparatus pertaining to the present invention, with reference to the drawings.

### 1. Structure of Image Forming Apparatus

Firstly, the following describes a structure of the image forming apparatus pertaining to the embodiment.

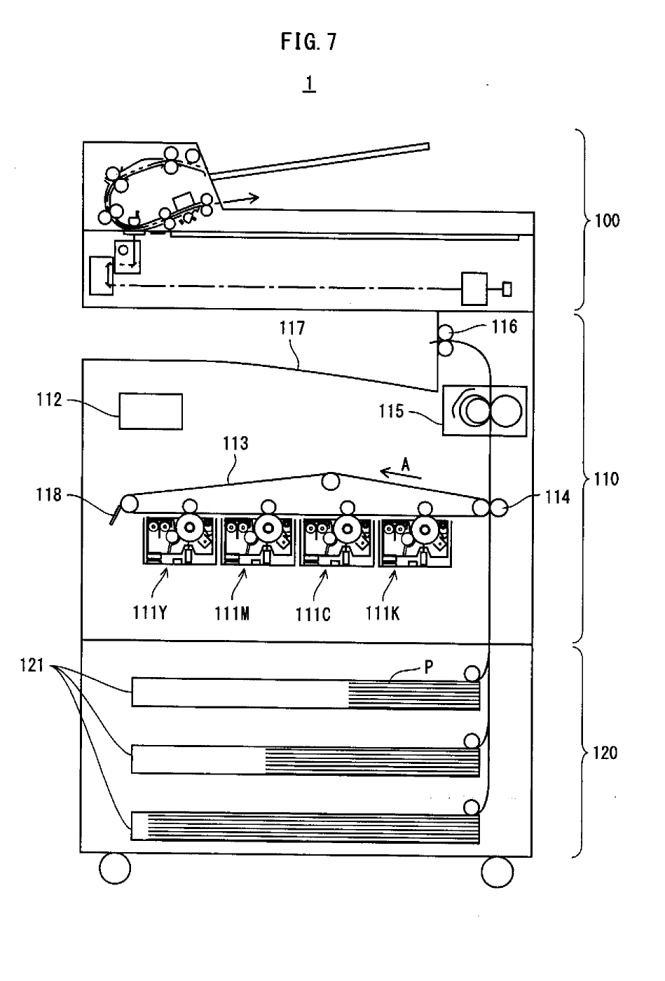

FIG. 7 shows a main structure of the image forming apparatus pertaining to the embodiment. As shown in FIG. 7, an image forming apparatus 1 includes a document reader 100, an image forming section 110, and a paper feeder 120. The document reader 100 generates image data by optically reading a document.

The image forming section 110 includes image forming units 111Y to 111K, a controller 112, an intermediate transfer belt 113, a secondary transfer roller pair 114, a fixing device 115, a sheet ejecting roller 116, an ejected-sheet tray 117, and a cleaner 118.

The image forming units 111Y to 111K respectively form toner images of yellow (Y), magenta (M), cyan (C) and black (K) under control of the controller 112, and electrostatically transfer (i.e., primarily transfer) the toner images onto the intermediate transfer belt 113 such that the toner images are superimposed. The intermediate transfer belt 113 is an endless belt that rotates in the direction of an arrow A so as to convey the toner images to the secondary transfer roller pair 114.

The paper feeder 120 includes feeding cassettes 121 each containing recording sheets P of a different size, and supplies the recording sheets P to the image forming section 110. The supplied recording sheets P are conveyed to the secondary transfer roller pair 114 in parallel with the transportation of the toner images formed on the intermediate transfer belt 113.

The secondary transfer roller pair 114 is composed of a pair of rollers having a potential difference and being pressed against each other to form a transfer nip portion. At the transfer nip portion, the toner images on the intermediate transfer belt 113 are electrostatically transferred onto the recording sheets P (i.e., secondary transfer). The recording sheets P, onto which the toner images have been transferred, are conveyed to the fixing device 115.

The fixing device 115 employs an electromagnetic induction-heating method. The fixing device 115 heats and fuses the toner images, and then presses the toner images against the recording sheets P. The recording sheets P, on which the toner images have been fused, are ejected onto the ejected-sheet tray 117 by the sheet ejecting roller 116.

### 2. Structure of Fixing Device 115

Next, the following describes a structure of the fixing device 115.

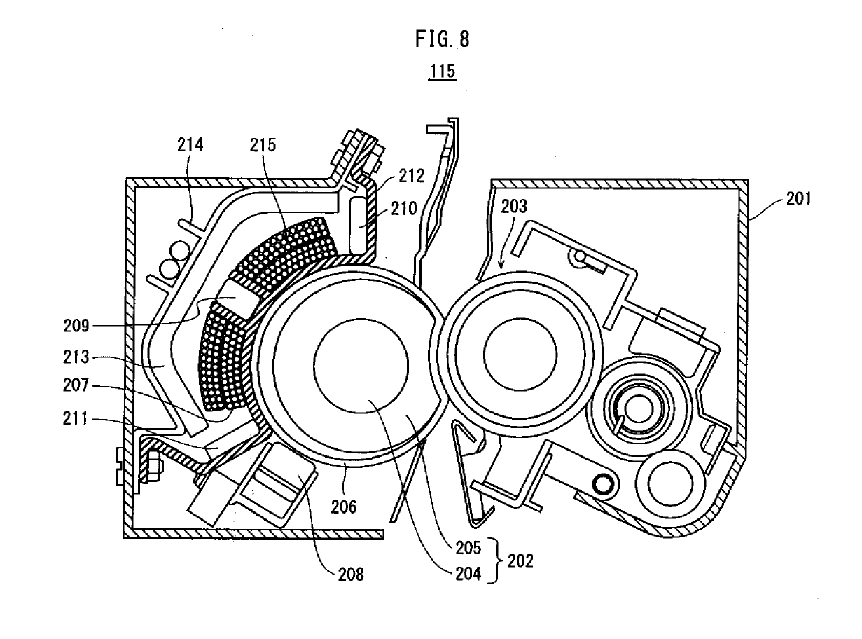

FIG. 8 is a cross-sectional view showing a main structure of the fixing device 115. As shown in FIG. 8, the fixing device 115 includes within a housing 201 a fixing roller 202 and a pressurizing roller 203. Rotational axes of the fixing roller 202 and the pressurizing roller 203 are in parallel with each other. The fixing device 115 presses the fixing roller 202 against the pressurizing roller 203 to sandwich the fixing belt 206 between the fixing roller 202 and the pressurizing roller 203, and rotates the pressurizing roller 203 by a drive motor (not illustrated).

The fixing roller 202 includes an insulating elastic layer 205 that is made of materials such as silicone sponge around a circumferential surface of an elongated metal core 204. The metal core is, for example, made of metal such as aluminum and stainless and has a diameter of 18 mm. The insulating elastic layer 205 is made of heat-resistant rubber, such as silicone rubber or fluoro rubber, or a foamed material obtained by foaming such rubber. Alternatively, the insulating elastic layer 205 may be formed by layering the heat-resistant rubber and the foamed material. The insulating elastic layer 205 has a thickness of, for example, 5 mm.

An endless fixing belt 206 is freely fit around a circumferential surface of the fixing roller 202. That is, an outer diameter of the fixing roller 202 is smaller (e.g., 28 mm) than an inner diameter of the fixing belt 206. The fixing roller 202 is in contact with the fixing belt 206 at a fixing nip N. There is a gap (space) between the fixing roller 202 and the fixing belt 206 except for the fixing nip N.

With the above structure, an area through which heat from the fixing belt 206 transfers to the fixing roller 202 becomes small compared with a case in which the fixing belt 206 closely attaches to the fixing roller 202, and it is possible to reduce heat transfer loss caused when a part of heat generated by the fixing belt 206 transfers via the metal core of the fixing roller 202 to the housing of the fixing device 115 that rotatably supports the metal core. Accordingly, high heat efficiency can be realized.

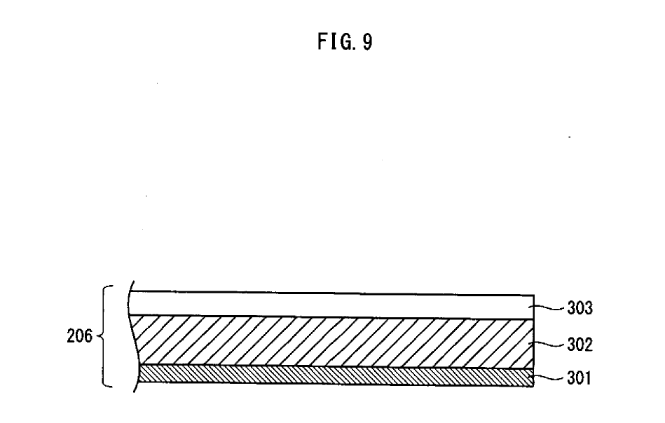

As shown in FIG. 9, the fixing belt 206 is formed by layering three layers including a metal heat generating layer 301, an elastic layer 302 and a release layer 303 in this order with the metal heat generating layer 301 being closest to the circumferential surface of the fixing roller 202. The metal heat generating layer 301 is formed of a Ni electroformed sleeve, and generates heat by electromagnetic induction by an alternating magnetic flux generated by a main excitation coil 207 or an auxiliary excitation coil 215. In order to improve strength of the fixing belt 206, a heat resistant reinforced layer may be added under the metal heat generating layer 301.

The pressurizing roller 203 is formed by layering an elastic layer and a release layer in the stated order on a circumferential surface of an elongated metal core. The pressurizing roller 203 is provided outside a belt rotation path of the fixing belt 206 and pressed (not illustrated) against the fixing roller 202 via the fixing belt 206 from outside of the fixing belt 206 by a pressing mechanism. In this way, the fixing nip N is formed between a surface of the fixing roller 202 and a surface of the fixing belt 206. An outer diameter of the pressurizing roller 203 is preferably in a range of 20 mm to 100 mm inclusive. In the present embodiment, the outer diameter of the pressurizing roller 203 is 35 mm.

The metal core has a hollow pipe-shape, and is made of metal such as aluminum or iron. An outer diameter of the metal core is, for example, 27 mm. A thickness of the metal core is preferably in a range of 0.1 mm to 10 mm inclusive. In the present embodiment, the thickness of the metal core is 2.5 mm. Note that the metal core may have a solid cylindrical shape or a Y-shaped cross-section.

The elastic layer is made of heat-resistant rubber, such as silicone rubber or fluoro rubber, or a foamed material obtained by foaming such rubber. A thickness of the elastic layer is preferably in a range of 1 mm to 20 mm inclusive. In the present embodiment, the thickness of the elastic layer is 4 mm.

The release layer is made of a fluororesin tube or a fluororesin coating that uses PFA (perfluoroalkoxy). The release layer may be conductive so as to prevent offset phenomenon of toner which is caused by electrostatic charge. A thickness of the release layer is preferably in a range of 5 μm to 100 μm inclusive. In the present embodiment, the thickness of the release layer is 30 μm.

The pressurizing roller 203 is rotated by a driving mechanism (not illustrated). In correspondence with rotation of the pressurizing roller 203, the fixing belt 206 and the fixing roller 202 are rotated. Note that instead of rotatably driving the pressurizing roller 203 by a drive motor, the fixing belt 206 and the pressurizing roller 203 may be rotated by rotating the fixing roller 202.

Moreover, in vicinity to the circumferential surface of the fixing belt 206, a temperature detecting element (sensor) 208 is disposed. The temperature detecting element 208 that is out of contact with the fixing belt 206 detects a signal indicating a surface temperature of substantially a central portion of the circumferential surface in a rotational axis direction thereof, and then transmits the detected signal. The controller 120 receives the detected signal and controls power supply to the main excitation coil 207 and the auxiliary excitation coil 215 so that the temperature of fixing belt 206 is controlled to be a predetermined value.

The main excitation coil 207, the auxiliary excitation coil 215, a center core 209 and hem cores 210 and 211 are held by a coil bobbin 212, and a plurality of main cores 213 are held by a core holding member 214. The main excitation coil 207 and the auxiliary excitation coil 215 can generate a magnetic flux with necessary density such that a part of the fixing belt 206 whose width corresponds to a width of a region where either of the maximum recording sheets and the small-size recording sheets pass through is heated up to a temperature that is necessary for the fixing belt 206 to fix toner images on the recording sheets (hereinafter, fixing temperature).

The center core 209, the hem cores 210 and 211, and the main cores 213 are made of a magnetic material with high permeability and low loss characteristics, such as a ferrite alloy and a permalloy alloy, and form a magnetic circuit with the fixing belt 206 and the main excitation coil 207. Thus, it is possible to prevent leaks of a magnetic flux to outside of the magnetic circuit, and accordingly heat generation efficiency improves. Note that in the present embodiment, the main cores 213 are rib-like, and provided along the fixing roller 202 in the rotational axis direction thereof.

The main cores 213 are bent like ribs so as to cover an outer surface of the main excitation coil 207. The main cores 213 that are some to dozen in number are held by the core holding member 214 at a predetermined interval therebetween in a direction parallel to an axis direction of the fixing roller 202. Two of the main cores 213 that are positioned at both ends in the axis direction have high magnetic coupling in order to compensate heat dissipation from both ends of the fixing belt.

Each of the center core 209 and the hem cores 210 and 211 has an elongated shape and is parallel to the axis direction of the fixing roller 202, and is bonded to the coil bobbin 212 with use of a heat resistant adhesive agent such as a silicone adhesive agent. Each of the hem cores 210 and 211 may be divided into two in the axis direction, but it is preferable that each of the hem cores 210 and 211 be arranged without space therebetween.

The center core 209 uniformly leads a magnetic flux generated by the main excitation coil 207 to the fixing belt 206. A magnetic flux penetrating through the fixing belt 206 induces eddy current, and then the fixing belt 206 generates Joule heat.

The coil bobbin 212 and the core holding member 214 are fixed by bolts and nuts at hem portions thereof. Alternatively, components other than the bolts and nuts, such as rivets may be used.

The main excitation coil 207 is held by the coil bobbin 212. The auxiliary excitation coil 215 is positioned on a central portion of the main excitation coil 207 in the rotational axis direction of the fixing belt 206 so as to correspond to the region where the small-size recording sheets pass through. The auxiliary excitation coil 215 is attached firmly to an outer surface of the main excitation coil 207 and an insulating sheet is sandwiched between the auxiliary excitation coil 215 and the main excitation coil 207. Note that the central portion represents an area of the main excitation coil 207 except for the both ends thereof, and the center of the main excitation coil 207 and the center of the auxiliary excitation coil 215 may not necessarily match.

Each of the main excitation coil 207 and the auxiliary excitation coil 215 is connected to an unillustrated high-frequency inverter (high-frequency power source), and high-frequency power of 10-100 kHz and 100-2000 W is supplied to each of the main excitation coil 207 and the auxiliary excitation coil 215. Accordingly, each of the main excitation coil 207 and the auxiliary excitation coil 215 is preferably made by winding litz wire consisting of thin wires that are covered with heat resistant resin and bundled together. The present embodiment employs the main excitation coil 207 and the auxiliary excitation coil 215 that are each made by winding the litz wire 10 turns. The litz wire consists of 114 wires bundled and twisted together and a diameter of each of the wires is Ø0.17.

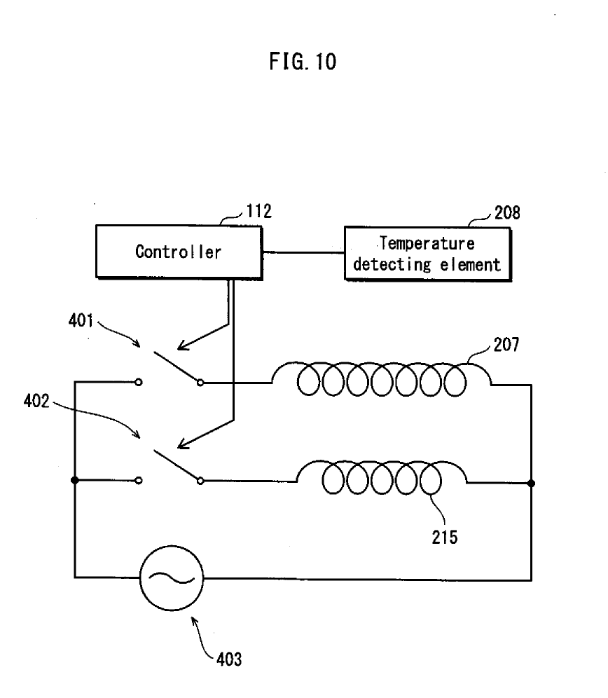

FIG. 10 shows a circuit structure for controlling power supply to the main excitation coil 207 and the auxiliary excitation coil 215. As shown in FIG. 10, the main excitation coil 207 is electrically connected to a high-frequency inverter 403 through a switching relay 401. The auxiliary excitation coil 215 is electrically connected to the high-frequency inverter 403 through a switching relay 402. The switching relays 401 and 402 are each under control of the controller 112.

The controller 112 causes one of the switching relays 401 and 402 to be ON in accordance with a size of fed recording sheets, and supplies high-frequency power to one of the main excitation coil 207 and the auxiliary excitation coil 215 so as to heat the fixing belt 206 by electromagnetic induction. The controller 112 monitors a temperature of the region where the recording sheets pass through with use of the temperature detecting element 208, and when the temperature reaches a predetermined value, the controller 112 disconnects the switching relays 401 and 402 so as to stop temperature rise. Thereby, the region where the recording sheets pass through of the fixing belt 206 remains at the fixing temperature.

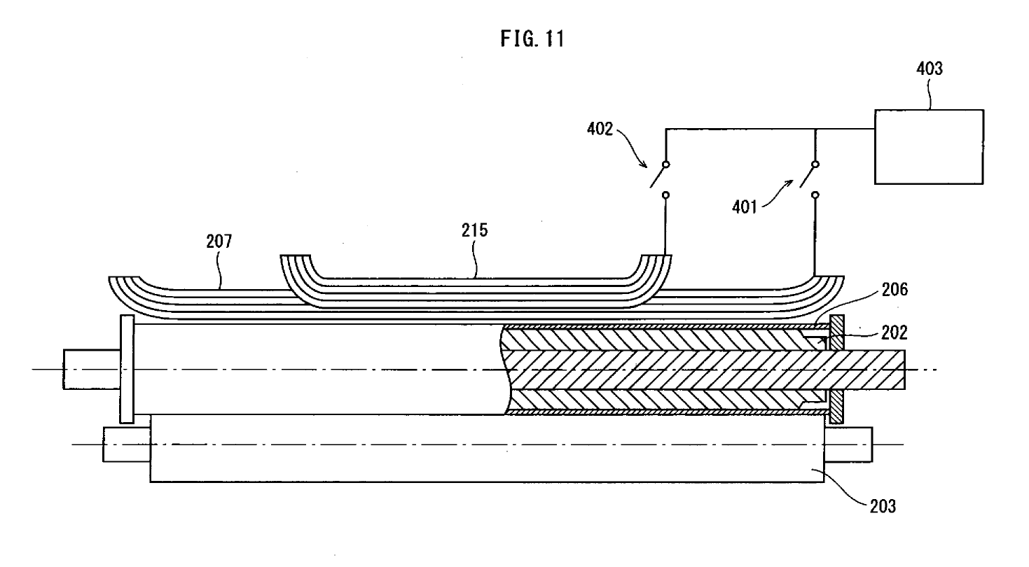

FIG. 11 is a partially cutaway lateral view showing a positional relationship between the main excitation coil 207 and the auxiliary excitation coil 215 in the rotational axis direction of the fixing roller 202. As shown in FIG. 11, the auxiliary excitation coil 215 has an effective heating length that corresponds to the small-size recording sheets and is shorter than an effective heating length of the main excitation coil 207.

Also, the auxiliary excitation coil 215 is layered substantially on a central portion of the main excitation coil 207 in the rotational axis direction of the fixing roller 202. In addition, although not shown in FIG. 11, the main excitation coil 207 and the auxiliary excitation coil 215 firmly attach to each other, sandwiching an insulating sheet therebetween.

Note that, as a distance between an excitation coil and the fixing belt 206 becomes larger, density of the magnetic flux penetrating through the fixing belt 206 decreases, and then heat generation efficiency by electromagnetic induction decreases. Generally, as a size of the recording sheets becomes larger, a more amount of heat is required for fixing. However, there is a limit to power to be supplied to the excitation coils due to conditions such as power source capacity.

Accordingly, it is preferable that the main excitation coil 207 that requires higher power be positioned closest to the fixing belt 206. In addition, in the case where a plurality of auxiliary excitation coils 215 are provided, the plurality of auxiliary excitation coils 215 should be positioned closer to the fixing belt 206 in descending order of effective heating length and required power. Thereby, even when toner images are fixed on recording sheets having a larger size, power shortage can be prevented.

As described above, as a distance between the excitation coils and the fixing belt 206 becomes larger, the heat generation efficiency decreases. However, if an effective heating length L2 of the auxiliary excitation coil 215 satisfies the following inequality with reference to an effective heating length L1 of the main excitation coil 207, it is possible to guarantee a required amount of heat by supplying the same amount of power as power supplied to the main excitation coil 207.

$$L 2 \leq L 1 \times \frac{η 2}{η 1}$$

Note that η1 is a thermal conversion efficiency of the main excitation coil 207, and η2 is a thermal conversion efficiency of the auxiliary excitation coil 215.

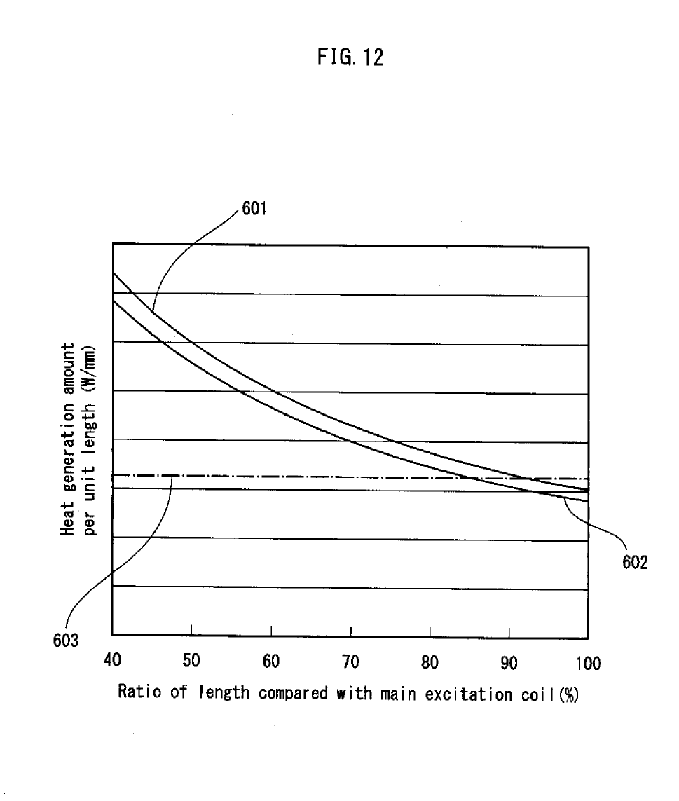

FIG. 12 is a graph showing a relationship between a ratio of the effective heating length of the auxiliary excitation coil to the main excitation coil and a heat generation amount per unit length generated by the auxiliary excitation coil having the above ratio within an effective heating area of the fixing belt. Note that in FIG. 12, a solid line 601 indicates a heat generation amount of a first auxiliary excitation coil, which is second closest to the fixing belt after the main excitation coil, and a solid line 602 indicates a heat generation amount of a second auxiliary excitation coil that is positioned on the first auxiliary excitation coil. A dashed line 603 indicates a heat generation amount required by the main excitation coil.

As shown in FIG. 12, in order to cause the first auxiliary excitation coil to reliably generate the same amount of heat as the main excitation coil, it is necessary that the effective heating length of the first auxiliary excitation coil is equal to or less than 93% of the effective heating length of the main excitation coil. Similarly, if the effective heating length of the second auxiliary excitation coil is equal to or less than 86% of the effective heating length of the main excitation coil, the second auxiliary excitation coil reliably generates the same amount of heat as the main excitation coil.

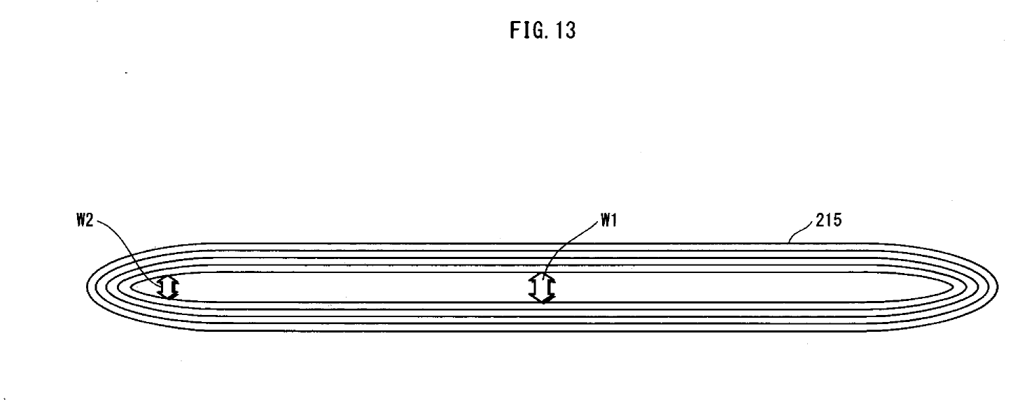

FIG. 13 is a plan view showing a shape of the auxiliary excitation coil 215. As shown in FIG. 13, the auxiliary excitation coil 215 has a center hole in a plan view, and a width W2 of the center hole is smaller than a width W1 of the center hole. The width W1 is a width of a central position of the center hole in a longitudinal direction thereof, and the width W2 is a Width of an end portion of the center hole in the longitudinal direction. The heat generation efficiency of the auxiliary excitation coil 215 is higher at the center hole with a larger width, and lower at the center hole with a smaller width. Therefore, when the auxiliary excitation coil 215 heats the fixing belt 206 by electromagnetic induction, temperature gradient at a boundary between an effective heating area of the auxiliary excitation coil 215 and outside thereof is mild.

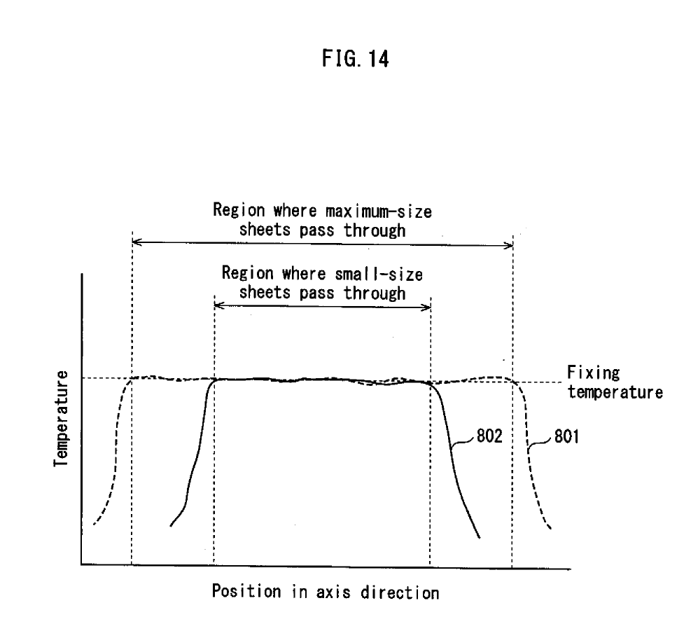

FIG. 14 is a graph showing a temperature distribution during electromagnetic induction heating by the main excitation coil 207 and a temperature distribution during electromagnetic induction heating by the auxiliary excitation coil 215 in the rotational axis direction of the fixing belt 206. Note that a dashed line 801 indicates a temperature distribution in the case of the main excitation coil 207, and a solid line 802 indicates that a temperature distribution in the case of the auxiliary excitation coil 215.

As shown in FIG. 14, when the main excitation coil 207 generates heat by electromagnetic induction, the region where the maximum-size recording sheets pass through is at substantially the fixing temperature. In addition, when the auxiliary excitation coil 215 generates heat by electromagnetic induction, the region where the small-size recording sheets pass through is at substantially the fixing temperature. On the other hand, a temperature outside of the region is low and accordingly overheating can be prevented. Also, the auxiliary excitation coil 215 has milder temperature gradient outside the region where recording sheets pass through than the main excitation coil 207. Thereby, it is possible to prevent undesired variations in fixing that is caused by a difference in luster level when the maximum-size recording sheets pass through after the small-size recording sheets pass through.

Thus, the fixing device pertaining to the present embodiment can effectively prevent overheating in the regions where recording sheets do not pass through. In addition, reduction in size, weight, and cost of the fixing device can be realized without problems such as undesired variations in fixing and reduction of heat generation efficiency.

### [3] Modifications

The present invention has been described based on the above embodiment. However, it is natural that the contents of the present invention are not limited to the above embodiment. For example, the following modifications are possible.

(1) The above embodiment has explained the case where one of the main excitation coil 207 and the auxiliary excitation coil 215 is used in accordance with a size of recording sheets to be passed. The present invention is of course not limited to this. For example, the following structure is acceptable.

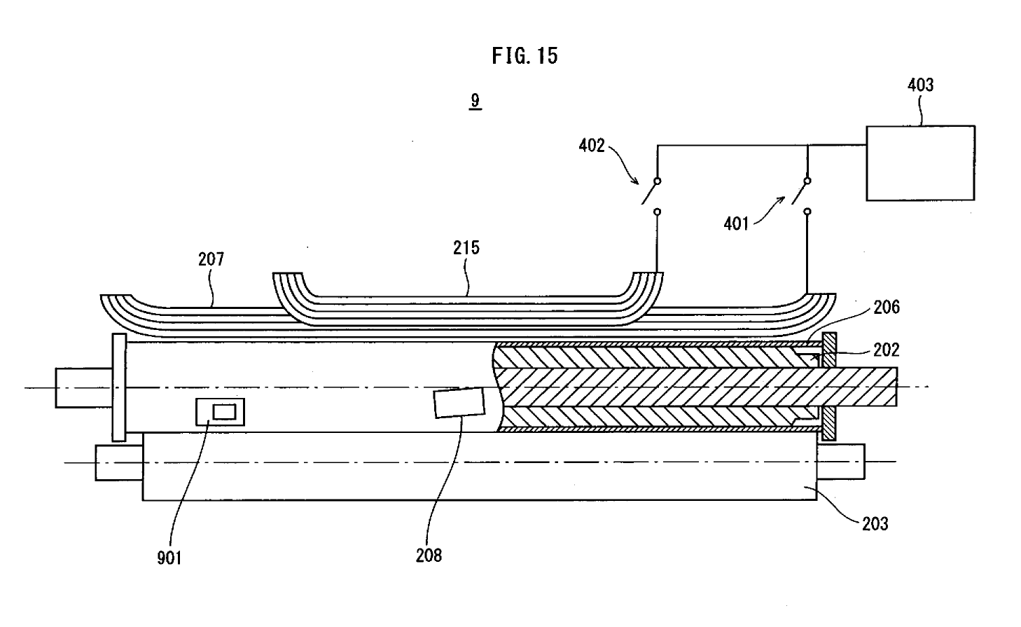

FIG. 15 is an external view of a main structure of the fixing device pertaining to the present modification. In the following description, a member that has been described in the above embodiment is referred to by the same reference sign. As shown in FIG. 15, a fixing device 9 pertaining to the present modification includes, in addition to substantially the same structure as the fixing device 115 pertaining to the above embodiment, a temperature detecting element 901 for monitoring a surface temperature of the fixing belt 206 in the regions where recording sheets do not pass through.

When images are being fixed on small-size recording sheets, the controller (not illustrated) refers to the surface temperature of the fixing belt 206 in the region where the small-size recording sheets do not pass through, which is monitored by the temperature detecting element 901 and connects one of the main excitation coil 207 and the auxiliary excitation coil 215 to the high-frequency inverter 403. Note that instead of the temperature detecting element 901, another temperature sensor may be used.

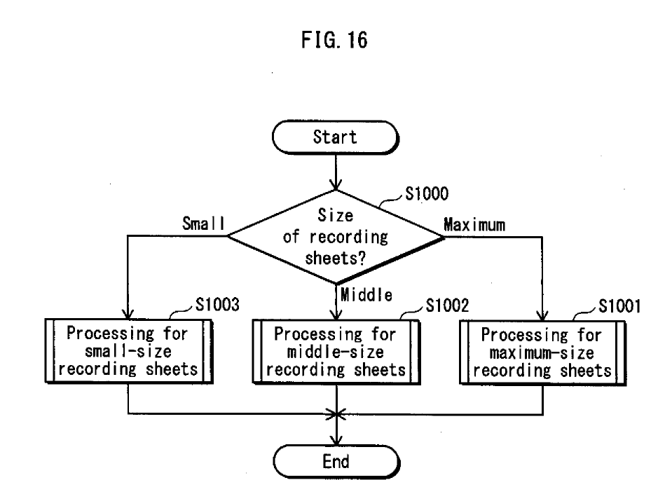

FIG. 16 is a flowchart showing control of power supply to the main excitation coil 207 and the auxiliary excitation coil 215, which is performed by a controller pertaining to the present modification. As shown in FIG. 16, the controller checks a size of recording sheets prior to fixing. In the case of the maximum-size recording sheets whose width corresponds to the effective heating length of the main excitation coil 207 (S1000: Maximum), processing for the maximum-size recording sheets is performed (S1001). In the case of recording sheets having a middle size (hereinafter, middle-size recording sheets) whose width is smaller than the effective heating length of the main excitation coil 207 and larger than the effective heating length of the auxiliary excitation coil 215 (S1000: Middle), processing for the middle-size recording sheets is performed (S1002). In the case of small-size recording sheets whose width corresponds to the effective heating length of the auxiliary excitation coil 215 (S1000: Small), processing for the small-size recording sheets is performed (S1003).

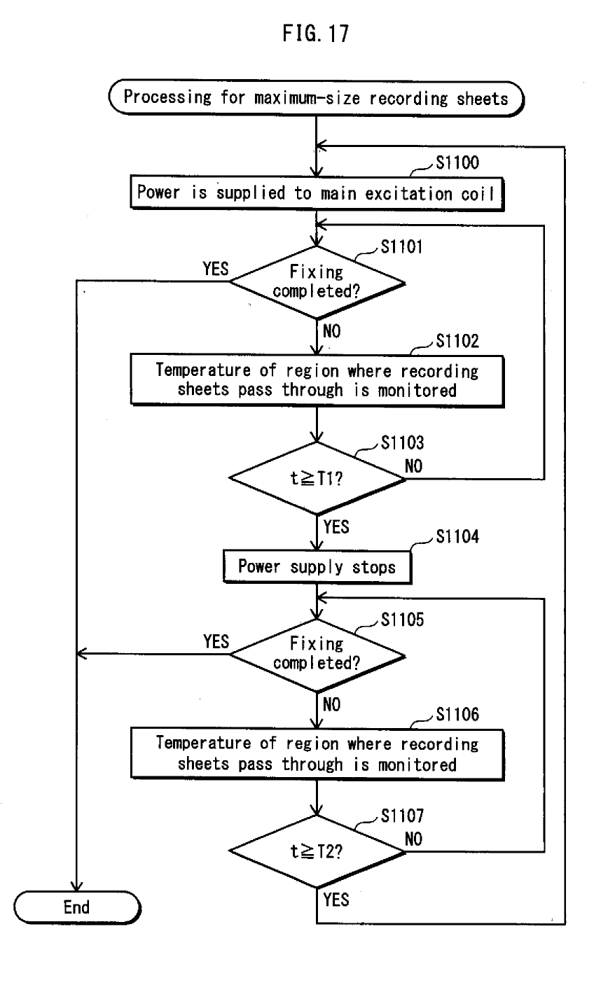

FIG. 17 is a flowchart showing processing for the maximum-size recording sheets. As shown in FIG. 17, in the processing for the maximum-size recording sheets, firstly, the high-frequency inverter 403 is connected to the main excitation coil 207 to supply power (S1100). After fixing images on the maximum-size recording sheets (S1101: YES), the processing ends.

When fixing continues (S1101: NO), the temperature detecting element 208 monitors a temperature t of the region where recording sheets pass through on the fixing belt 206 (S1102). If the temperature t is lower than a reference temperature T1 (S1103: NO), power supply to the main excitation coil 207 continues. Here, the reference temperature T1 is higher than but close to the fixing temperature in the range where abnormal fixing does not occur. When the temperature t of the region where the recording sheets pass through is higher than the reference temperature T1 (S1103: YES), power supply to the main excitation coil 207 stops (S1104). After fixing images on the maximum-size recording sheets (S1105: YES), the processing ends.

When fixing continues (S1105: NO), the temperature t of the region where the recording sheets pass through is monitored (S1106). When the temperature t of the region where the recording sheets pass through is higher than a reference temperature T2 (S1107: NO), power supply to the main excitation coil 207 remains stopped. When the temperature t of the region where the recording sheets pass through is lower than the reference temperature T2 (S1107: YES), power is supplied to the main excitation coil 207 (S1100). Here, the reference temperature T2 is lower than and close to the fixing temperature in the range where abnormal fixing does not occur. When images are being fixed on the maximum-size recording sheets, the temperature of the fixing belt 206 is kept substantially at the fixing temperature.

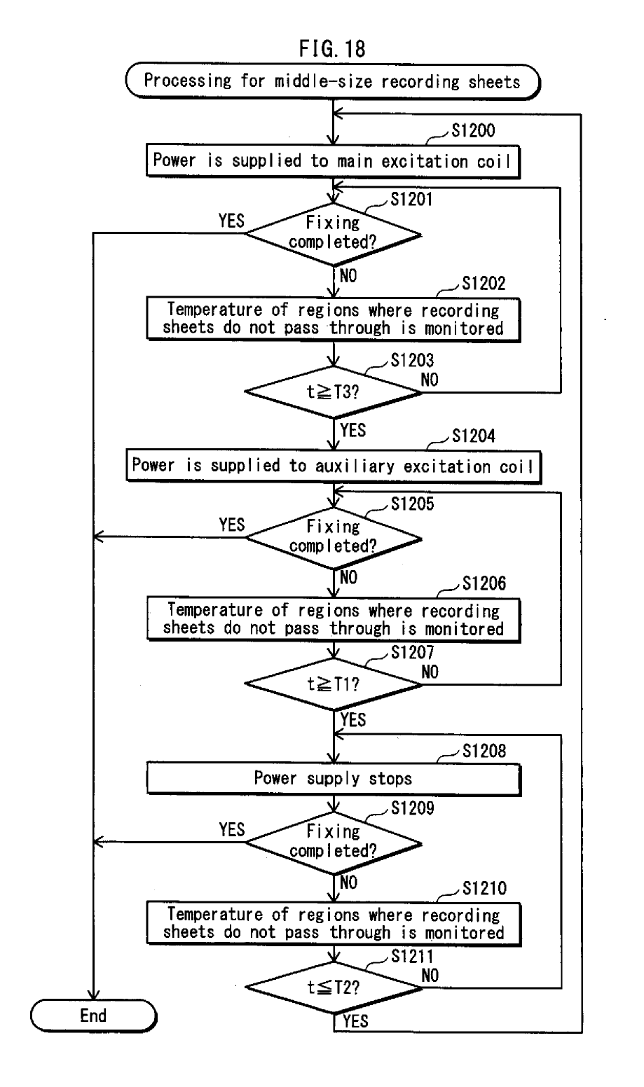

FIG. 18 is a flowchart showing processing for the middle-size recording sheets. As shown in FIG. 18, also in the processing for the middle-size recording sheets, firstly, the high-frequency inverter 403 is connected to the main excitation coil 207 to supply power (S1200). After fixing images on the middle-size recording sheets (S1201: YES), the processing ends.

When fixing continues (S1201: NO), the temperature detecting element 901 monitors a temperature t of the region where recording sheets do not pass through on the fixing belt 206 (S1202). If the temperature t is lower than a reference temperature T3 (S1203: NO), power supply to the main excitation coil 207 continues. Here, the reference temperature T3 is lower than a temperature of the regions where the middle-size recording sheets do not pass through in an overheated state. On the other hand, a temperature t of the region where the recording sheets pass through is higher than the reference temperature T3 (S1203: YES), power supply to the main excitation coil 207 stops and power is supplied to the auxiliary excitation coil 215 (S1204).

Thereby, overheating in the region where the middle-size recording sheets do not pass through can be prevented. After fixing images on the middle-size recording sheets (S1205: YES), the processing ends. When fixing continues (S1205: NO), the temperature t of the region where the recording sheets pass through is monitored (S1206). When the temperature t of the region where the recording sheets pass through is lower than the reference temperature T1 (S1207: NO), power supply to the main excitation coil 215 continues. When a temperature t of the regions where the recording sheets do not pass through is higher than the reference temperature T1 (S1207: YES), power supply to the auxiliary excitation coil 215 stops (S1208).

In this case, power is also not supplied to the main excitation coil 207. Thereby, it is possible to prevent the region where the recoding sheets pass through from departing from the fixing temperature and then being overheated. After fixing images on the middle-size recording sheets (S1209: YES), the processing ends. When fixing continues (S1209: NO), a temperature t of the region where the recording sheets pass through is monitored (S1210). When the temperature t of the region where the recording sheets pass through is higher than the reference temperature T2 (S1211: NO), power supply continues to be stopped. When the temperature t of the regions where the recording sheets do not pass through is lower than the reference temperature T2 (S1211: YES), power supply to the main excitation coil 207 resumes (S1200).

Thereby, in the case where a width of recording sheets is smaller than the effective heating length of the main excitation coil and larger than the effective heating length of the auxiliary excitation coil, like the middle-size recording sheets, overheating in the regions where recording sheets do not pass through can be prevented while keeping the temperature of the region where the middle-size recording sheets pass through at the fixing temperature.

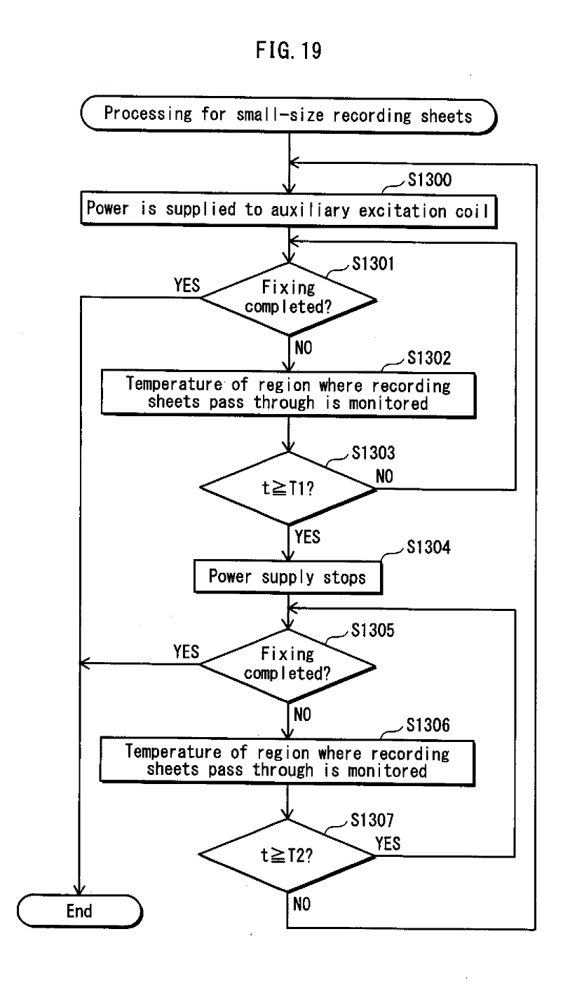

FIG. 19 is a flowchart showing processing for the small-size recording sheets. As shown in FIG. 19, in the processing for the small-size recording sheets, processing that is similar to the processing for the maximum-size recording sheets is performed. A difference is that the auxiliary excitation coil 215 is used instead of the main excitation coil 207. Firstly, the high-frequency inverter 403 is connected to the auxiliary excitation coil 215 to supply power (S1300). After fixing images on the small-size recording sheets (S1301: YES), the processing ends.

When fixing continues (S1301: NO), the temperature detecting element 208 monitors a temperature t of the region where recording sheets pass through on the fixing belt 206 (S1302). If the temperature t is lower than the reference temperature T1 (S1303: NO), power supply to the auxiliary excitation coil 215 continues. When the temperature t of the region where the recording sheets pass through is higher than the reference temperature T1 (S1303: YES), power supply to the auxiliary excitation coil 215 stops (S1304). After fixing images on the small-size recording sheets (S1305: YES), the processing ends.

When fixing continues (S1305: NO), the temperature t of the region where the recording sheets pass through is monitored (S1306). When the temperature t of the region where the recording sheets pass through is higher than the reference temperature T2 (S1307: YES), power supply to the auxiliary excitation coil 215 remains stopped. When the temperature t of the region where the recording sheets pass through is lower than the reference value T2 (S1307: NO), power is supplied to the auxiliary excitation coil 215 (S1300). When images are being fixed on the small-size recording sheets, a temperature of the fixing belt 206 in the region where small-size recording sheets pass through remains substantially at the fixing temperature, as described above. Note that, the reference temperature T2 is a predetermined temperature lower than the reference temperature T1.

(2) The above embodiment has described the case where overheating in the region where recording sheets do not pass through is prevented by combining the main excitation coil and the auxiliary excitation coil. The present invention is of course not limited to this. In addition to the above, a demagnetization coil may be combined.

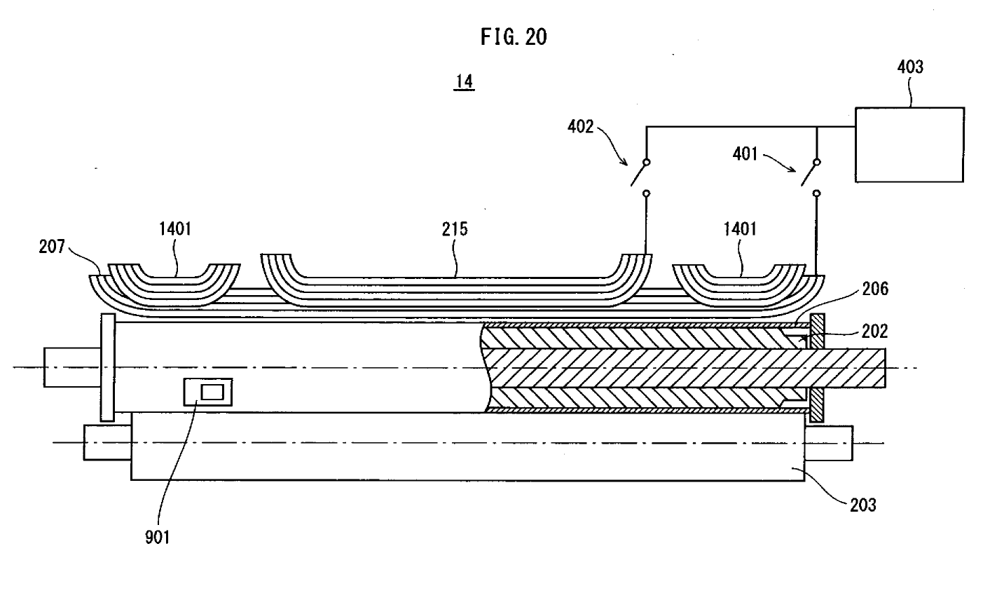

FIG. 20 shows a main structure of a fixing device according to the present modification. As shown in FIG. 20, a fixing device 14 includes demagnetization coils 1401 layered on the both end portions of the main excitation coil 207 in a rotational axis direction of the fixing belt 206. The demagnetization coils 1401 are provided at positions corresponding to the regions where the middle-size recording sheets do not pass through. The demagnetization coils 1401 are each connected to a switch under control of the controller. The switch is ON when images are fixed on the middle-size recording sheets so that demagnetization effect of the demagnetization coils 1401 works, and the switch is OFF when images are fixed on the maximum-size recording sheets or the small-size recording sheets so that the demagnetization effect of the demagnetization coils 1401 does not work.

Thereby, even when the above modification (1) cannot control overheating in the regions where the recording sheets do not pass through, it is possible to prevent overheating in the regions where the recording sheets do not pass through with use of the demagnetization coils.

(3) The above embodiment has described the case of using a single auxiliary excitation coil. The present invention is of course not limited to this. A plurality of auxiliary excitation coils may be used in accordance with the number of sizes of fed recording sheets.

### [4] Features and Effects of the Present Invention

A fixing device of the present invention includes a fixing rotational body and fixes toner images on recording sheets of various sizes by using the fixing rotational body, the fixing device comprising: a main excitation coil that heats the fixing rotational body by electromagnetic induction and has an effective heating length L1 corresponding to a recording sheet of a maximum size; an auxiliary excitation coil that heats the fixing rotational body by electromagnetic induction and has an effective heating length L2 that is shorter than the effective heating length L1 of the main excitation coil; a high-frequency power source that supplies power to the main excitation coil and the auxiliary excitation coil; and a switch that selectively connects the main excitation coil and the auxiliary excitation coil to the high-frequency power source, wherein the main excitation coil is positioned along a part of an outer circumferential surface of the fixing rotational body, the auxiliary excitation coil is positioned farther from the fixing rotational body than the main excitation coil is and layered on a substantially central portion of the main excitation coil in a longitudinal direction of the main excitation coil, and the effective heating length L2 of the auxiliary excitation coil satisfies the following relationship: L2≦L1·η2/η1, where η1 is a thermal conversion efficiency of the main excitation coil and η2 is a thermal conversion efficiency of the auxiliary excitation coil.

Thereby, since the auxiliary excitation coil is provided outside the main excitation coil as viewed from the fixing rotational body, and layered substantially on the central portion of the main excitation coil in the longitudinal direction thereof, overheating in the regions where recording sheets do not pass through can be effectively prevented, and reduction in size, weight, and cost of the fixing device can be realized without problems such as uneven temperature distribution and reduction of heat generation efficiency.

In this case, the auxiliary excitation coil is provided in plurality, the plurality of the auxiliary excitation coils may have effective heating lengths that are different from each other, and the plurality of the auxiliary excitation coils may be layered on the main excitation coil so that the effective heating lengths decrease with distance from the main excitation coil. Thereby, when the maximum-size recording sheets that consume the most energy (power) are fed, higher heat generation efficiency can be retained and heat energy supplied to the recording sheets is guaranteed.

Also, the auxiliary excitation coil has a center hole, and a width of the center hole in a circumferential direction of the fixing rotational body at each end portion of the center hole in a rotational axis direction of the fixing rotational body may be smaller than a width of the center hole in the circumferential direction at a central portion of the center hole in the rotational axis direction. Thereby, when the small-size recording sheets are fed, rapid temperature change occurring at the both ends of the region where small-size recording sheets pass through can be suppressed, and accordingly, when recording sheets having a large size are fed after that, uneven fixation (glossiness) can be prevented.

Also, the switch may connect, to the high-frequency power source, one of the main excitation coil and the auxiliary excitation coil whose effective heating length is closer to a width of a fed recording sheet on which toner images are to be fixed than an effective heating length of the other. Thereby, overheating in the regions where the recording sheets do not pass through can be prevented.

Also, in order to raise a temperature of the fixing rotational body, the switch may connect, to the high-frequency power source, one of the main excitation coil and the auxiliary excitation coil whose effective heating length is longer than a width of a fed recording sheet on which toner images are to be fixed, and in order to reduce a temperature of the fixing rotational body, the switch may connect, to the high-frequency power source, one of the main excitation coil and the auxiliary excitation coil whose effective heating length is shorter than the width of the fed recording sheet on which toner images are to be fixed. Thereby, even in the case where an auxiliary excitation coil having an effective heating length that matches a width of fed recording sheets is not provided, overheating can be prevented by monitoring a temperature of the regions where the recording sheets do not pass through and switching excitation coils.

Also, a fixing device that includes a fixing rotational body and fixes toner images on recording sheets of various sizes by using the fixing rotational body, the fixing device comprising: a main excitation coil that heats the fixing rotational body by electromagnetic induction and has an effective heating length L1 corresponding to a recording sheet of a maximum size; an auxiliary excitation coil that heats the fixing rotational body by electromagnetic induction and has an effective heating length L2 that is shorter than the effective heating length L1 of the main excitation coil; a high-frequency power source that supplies power to the main excitation coil and the auxiliary excitation coil; and a switch that selectively connects the main excitation coil and the auxiliary excitation coil to the high-frequency power source, wherein the main excitation coil is positioned along a part of an outer circumferential surface of the fixing rotational body, the auxiliary excitation coil is positioned farther from the fixing rotational body than the main excitation coil is and layered on a substantially central portion of the main excitation coil in a longitudinal direction of the main excitation coil, and the effective heating length L2 of the auxiliary excitation coil satisfies the following relationship: L2≦L1·η2/η1, where η1 is a thermal conversion efficiency of the main excitation coil and η2 is a thermal conversion efficiency of the auxiliary excitation coil. If the effective heating length L2 of the auxiliary excitation coil satisfies the above range, it is possible to cause the auxiliary excitation coil to reliably generate the same amount of heat as the main excitation coil, even if an amount of power supply to the auxiliary excitation coil is not larger than an amount of power supply to the main excitation coil.

An image forming apparatus pertaining to the present invention includes the fixing device pertaining to the present invention. Thereby, an effect of the fixing device pertaining to the present invention can be obtained.

Although the present invention has been fully described by way of examples with reference to the accompanying drawings, it is to be noted that various changes and modifications will be apparent to those skilled in the art.

Therefore, unless otherwise such changes and modifications depart from the scope of the present invention, they should be construed as being included therein.

What is claimed is:

1. A fixing device that includes a fixing rotational body and fixes toner images on recording sheets of various sizes by using the fixing rotational body, the fixing device comprising:
a main excitation coil that heats the fixing rotational body by electromagnetic induction and has an effective heating length L1 corresponding to a recording sheet of a maximum size;
an auxiliary excitation coil that heats the fixing rotational body by electromagnetic induction and has an effective heating length L2 that is shorter than the effective heating length L1 of the main excitation coil;
a high-frequency power source that supplies power to the main excitation coil and the auxiliary excitation coil; and
a switch that selectively connects the main excitation coil and the auxiliary excitation coil to the high-frequency power source, wherein
the main excitation coil is positioned along a part of an outer circumferential surface of the fixing rotational body,
the auxiliary excitation coil is positioned farther from the fixing rotational body than the main excitation coil is and layered on a substantially central portion of the main excitation coil in a longitudinal direction of the main excitation coil, and
the effective heating length L2 of the auxiliary excitation coil satisfies the following relationship:
L2≦L1·η2/η1,
where η1 is a thermal conversion efficiency of the main excitation coil and η2 is a thermal conversion efficiency of the auxiliary excitation coil.

2. The fixing device of claim 1, wherein
the auxiliary excitation coil is provided in plurality,
the plurality of the auxiliary excitation coils have effective heating lengths that are different from each other, and
the plurality of the auxiliary excitation coils are layered on the main excitation coil so that the effective heating lengths decrease with distance from the main excitation coil.

3. The fixing device of claim 1, wherein
the auxiliary excitation coil has a center hole, and
a width of the center hole in a circumferential direction of the fixing rotational body at each end portion of the center hole in a rotational axis direction of the fixing rotational body is smaller than a width of the center hole in the circumferential direction at a central portion of the center hole in the rotational axis direction.

4. The fixing device of claim 1, wherein
the switch connects, to the high-frequency power source, one of the main excitation coil and the auxiliary excitation coil whose effective heating length is closer to a width of a fed recording sheet on which toner images are to be fixed than an effective heating length of the other.

5. The fixing device of claim 1, wherein
in order to raise a temperature of the fixing rotational body, the switch connects, to the high-frequency power source, one of the main excitation coil and the auxiliary excitation coil whose effective heating length is longer than a width of a fed recording sheet on which toner images are to be fixed, and
in order to reduce a temperature of the fixing rotational body, the switch connects, to the high-frequency power source, one of the main excitation coil and the auxiliary excitation coil whose effective heating length is shorter than the width of the fed recording sheet on which toner images are to be fixed.

6. An image forming apparatus, comprising:
a fixing device that includes a fixing rotational body and fixes toner images on recording sheets of various sizes by using the fixing rotational body, the fixing device comprising:
a main excitation coil that heats the fixing rotational body by electromagnetic induction and has an effective heating length L1 corresponding to a recording sheet of a maximum size;
an auxiliary excitation coil that heats the fixing rotational body by electromagnetic induction and has an effective heating length L2 that is shorter than the effective heating length L1 of the main excitation coil;
a high-frequency power source that supplies power to the main excitation coil and the auxiliary excitation coil; and
a switch that selectively connects the main excitation coil and the auxiliary excitation coil to the high-frequency power source, wherein
the main excitation coil is positioned along a part of an outer circumferential surface of the fixing rotational body,
the auxiliary excitation coil is positioned farther from the fixing rotational body than the main excitation coil is and layered on a substantially central portion of the main excitation coil in a longitudinal direction of the main excitation coil, and
the effective heating length L2 of the auxiliary excitation coil satisfies the following relationship:
L2≦L1·2/η1,
where η1 is a thermal conversion efficiency of the main excitation coil and η2 is a thermal conversion efficiency of the auxiliary excitation coil.
